(19) United States
(12) Patent Application Publication
(10) Pub. No.: US 2012/0295601 A1
(43) Pub. Date: Nov. 22, 2012

(54) System and Method for Providing a Mobile Phone Directory Service

(76) Inventor: Alexander Lang, Singapore (SG)

(21) Appl. No.: 13/328,878

(22) Filed: Dec. 16, 2011

Related U.S. Application Data
(60) Provisional application No. 61/423,683, filed on Dec. 16, 2010.

(51) Int. Cl. H04W 4/14

(52) U.S. Cl. 455/415

(57) ABSTRACT

A method and system for registering a mobile phone number with an operator registration service. The method comprising receiving an electronic message including a unique subscriber name provided by a mobile phone subscriber and extracting the unique subscriber name from the electronic message and a mobile phone number associated with the electronic message corresponding to the mobile phone subscriber. A name-number pair is generated with the extracted unique subscriber name and the mobile phone number. The name-number pair is indexed in a searchable directory database where it may be retrieved in response to receiving a call request message from a calling party, the call request message including the unique subscriber name and an origination phone number. The method further comprising establishing a call between the origination phone number and the mobile phone number.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention described herein generally relates to providing a searchable phone directory record that can be used to call a name-number pair.

### BACKGROUND TO THE INVENTION

At one time most people had a telephone number associated with a land line which connected a home phone with the local telephone company telephone exchange with a physical wire called a telephone line which may also be referred to in its totality as a land line. The land line had a name associated with the subscriber who rented the land line and that information was registered with the local telephone company in a telephone company information database called the Directory and usually there was a hard copy called the White Pages that every subscriber of a land line received a copy of The local telephone company was usually a monopoly and everyone in the local telephone company region who had a land line was registered in the local telephone company database and White Page listings.

The phone companies provided a convenient service called Directory Services where anyone could call the local telephone company operator and if one provided a name and address of a subscriber the operator would provide, for a fee, another subscribers telephone number. By calling a remote telephone operator service a user could also get a number for anyone around the world by calling foreign telephone operators ad directory services. Operator services were very popular, efficient, useful, and were used by many people around the world as a standard method of obtaining telephone numbers for people that they wanted to talk to.

With the breakup of the monopoly Telco's, and the introduction of many competing mobile phone operators who do not share their databases of subscribers, and the introduction of personal contact lists on mobile phones, the burden of managing phone numbers has fallen to the individual and very few people use operator service today. Adding to the confusion there is a great surge in prepaid cards. People who purchased prepaid cards often change their mobile numbers every time they purchase a new prepaid card. Further exacerbating the problem, there are many people who change their mobile phone numbers every time they travel to avoid roaming charges by “swapping” subscriber identity module (“SIM”) cards. It can be very difficult over time to track people's mobile phone numbers as personal contact lists get out of date. There is a need for a new type of operator services where mobile phone subscribers can register their mobile phone numbers so that anyone in the world can retrieve their number and connect to them.

A mobile phone in the present context refers to any mobile device including, but not limited to, cellular mobile telephones, iPads, tablets and other handheld wireless devices, etc., that are capable of sending short informational messages, e.g., an short message service (“SMS”) message, Multimedia Messaging Service (“MMS”) message, or Code Division Multiple Access (“CDMA”) formatted message and of course making wireless mobile phone calls to and from the PSTN. A mobile phone number (MPN) in the present context refers to the telephone number of a given mobile device (“MD”) that people call from other phones to connect to the mobile device commonly called the persons telephone number. In the industry many terms are used to describe a mobile phone number such as SIM card number, CDMA number, etc., all of which refer to the MPN.

The Internet has pointed the way in regards to dealing with duplicate names by using numbers and extensions separated by dots and the same methods can be applied intuitively to creating unique mobile phone names that can be used to establishing mobile phone connections or retrieving associated numbers. SMS has a unique characteristic in that each message includes the mobile phone number of the person who sent the message. SMS is also very secure and very difficult to tamper with making it a great tool to use for registering telephone numbers. Databases are massive, easily deployed, inexpensive, and many are web based today providing a method to manage and retrieve data from any point in the world. There is then a need for technology to efficiently bring back an operator service that is independent of the mobile phone service provider, or geographic location.

With the advent of social networking and mobile phones with the capability (at a minimum) of taking pictures and sending files, many people who have access to mobile phones but not PC's cannot participate in the social networking phenomena. Participation in social networking is possible if a directory existed to provide a system and method for mobile phone users to swap files in the context of social networking. There is a need therefore to extend the capabilities of a directory to include the capability of sharing data files. With the advent of smart phones and the capabilities of smart phones of recording sounds, taking pictures and creating text files and all sorts of messaging such as SMS, MMS and IM, the smart phone is the ideal tool for social networking A directory is an ideal platform for extending a directory service to include smart phone social networking services as people use websites to connect at the same time the directory can have a process to automatically create a special space for social networking files as well as uploading and downloading flies from specially tagged friends, allowing social interaction without the need for a PC. A Mobile Phone Directory can also keep track of IP address so subscribers can connect to each other by VoIP or SIP or TDM/PSTN in any combination without the need to know each others IP address or current phone numbers as the Mobile Phone Directory maintains the current IP address and current phone numbers for all subscribers and uses those numbers to create the connection between subscribers based on subscriber preference as set in the Directory Mobile Phone Application

### SUMMARY OF THE INVENTION

In the simplest version of the operator service according to one embodiment of the present invention, a special purpose wireless gateway that may be referred to as a directory gateway may be provisioned so that it has one or more specific associated mobile phone numbers. Any mobile phone subscriber in the world could then send an SMS message from anywhere in the world to this wireless gateway. If the SMS message contains a name of a subscriber, this name combined with a telephone number could be combined to provide a searchable phone directory record that will henceforth be called a name-number or a name-number pair.

The directory gateway may be a special purpose wireless gateway with special functionality designed to capture the name-number information, but is not only limited to capturing name-number information. The directory gateway can be designed such that a special process could unpack the SMS message content when the SMS message (SMS) is received at the directory gateway, extract a mobile phone number from the SMS, convert this name-number information to a standard message format such as a Transmission Control Protocol/Internet Protocol (“TCP/IP”) message format, and send this information to a directory database. The directory database may receive this information and run a search engine process with special features designed to look for duplicate names. If no duplicate names exist the unique name and the associated number may be stored in the directory database registering a mobile phone as a name-number. Once registered in the directory system, a registered party may be referred to as a subscriber.

One of the key characteristics of the directory system is that the mobile phone number may be embedded in a security number directory field in the directory database for security purposes so that if any changes need to be made, they can only be made from any phone with exact mobile phone number or the original SIM card, which includes the embedded subscriber mobile phone number, preventing people from hijacking numbers in the directory database. Alternatively the IMSI number could be extracted from the phone and in this case the security number is associated with the particular phone and not the mobile phone number.

The advantages of such a directory system may be as follows: it is very simple for any mobile phone user to register their name-number in the directory, by simply sending a name in an SMS message to the directory. Registration can be done without going to a web portal. Registration is secure using an SMS. Changes to the name-number can be done from a web portal or from a mobile phone using the same SIM card as the registration SIM card. An automated call processing engine can be added so that anyone can SMS the name to the directory from any mobile phone and the directory database can format a special message referred to as a call request message, which can be used by a Telco switching system to process a phone call between the SMS requesting party and the directory subscriber.

Special purpose directory may comprise all the components of the directory including a directory database, directory web portal, directory call processing, directory interactive voice response (IVR), and directory conference that may herein be collectively referred to as a directory system that can be set up so that special directory process can serve special directory needs. For example, a provider of restaurant information in a city could put up a restaurant directory system so that any restaurant wanting to be part of the restaurant directory need only opt-in by sending an SMS from the restaurant establishment owners mobile phone such as “GOOD EATS” to the restaurant directory, receiving back a unique user name, pass code and URL. Then through the web, number associated with “GOOD EATS” may be modified to the real “GOOD EATS” number and this number can only be modified by the holder of the registration SIM card, which may be referred to as the registering SIM card. Special purposes directory systems can be set up for enterprises wishing to have a single database where all of their employees can list their mobile phone numbers and manage them. Other directories can amalgamate all of the information into a single mass directory which may be referred to as a super directory. The permutations and combinations are unlimited as to use and purpose from charities registration to voter registration.

There are very unique properties of mobile phones and the mobile phone network that are not inherent in the PC world, namely security. The mobile phone network was developed as a real-time secure synchronous network whereby calls are made under the control of a common control channel, often referred to as SS7 or C7. This security makes the concept or idea of a world wide mobile phone directory more appealing as the system of the present invention can incorporate all of the advantages of common control channel signaling. As well, since the directory database can bring entire databases of millions of mobile phone users together for the purpose of simplicity of connection, there is an opportunity to leverage disparate directories to provide social network features in a secure manner, which is impossible in the world of PC's interconnected via the Internet. For example if a mobile phone user such as an iPhone user takes a picture and they are a subscriber of the mobile phone directory service according to the present invention, he or she could send the picture in a simple format or include text to the mobile phone directory and the directory could read the user's mobile phone number, verify the user, look at the profile of the user and allowances, and if allowed, extract the picture and store this picture in the user's personal mobile phone directory space without ever needing to go to the internet to complete the transaction, rather completing the transaction over the secure Telco network. Optionally the user may select a WiFi spot and connect to the mobile phone directory via TCP/IP if there is little concern over security. Alternative embodiments contemplate a combination of TCP/IP and Instant Messaging, whereby manually embedded security numbers in the IM message could provide the same solution but in a much less secure manner. With the opportunity to provide security, a whole new version of secure, social networking opportunities emerge for those who wish to socially network by using the security of the mobile phone directory service to add a personal social network space.

There are specific challenges to the directory system such as handling duplicate names and numbers, billing and payment issues, call processing, conference bridging, IVR support for special messaging etc. All of these obstacles have solutions which are described by the present disclosure of the directory system and the claims.

### BRIEF DESCRIPTION OF THE DRAWINGS

FIG. 1 illustrates a block diagram illustrating a system for registering numbers and completing calls using the mobile phone directory according to one embodiment of the present invention;

FIG. 2 illustrates a flowchart of a method for registering numbers using the mobile phone directory according to an embodiment of the present invention;

FIG. 3 illustrates a flowchart of completing calls using the mobile phone directory according to one embodiment of the present invention;

FIG. 4 illustrates a flowchart for creating a social networking directory according to one embodiment of the present invention;

FIG. 5 illustrates a personal user space according to one embodiment of the present invention; and

FIG. 6 illustrates a connection activity page according to one embodiment of the present invention.

### DETAILED DESCRIPTION OF THE EMBODIMENTS

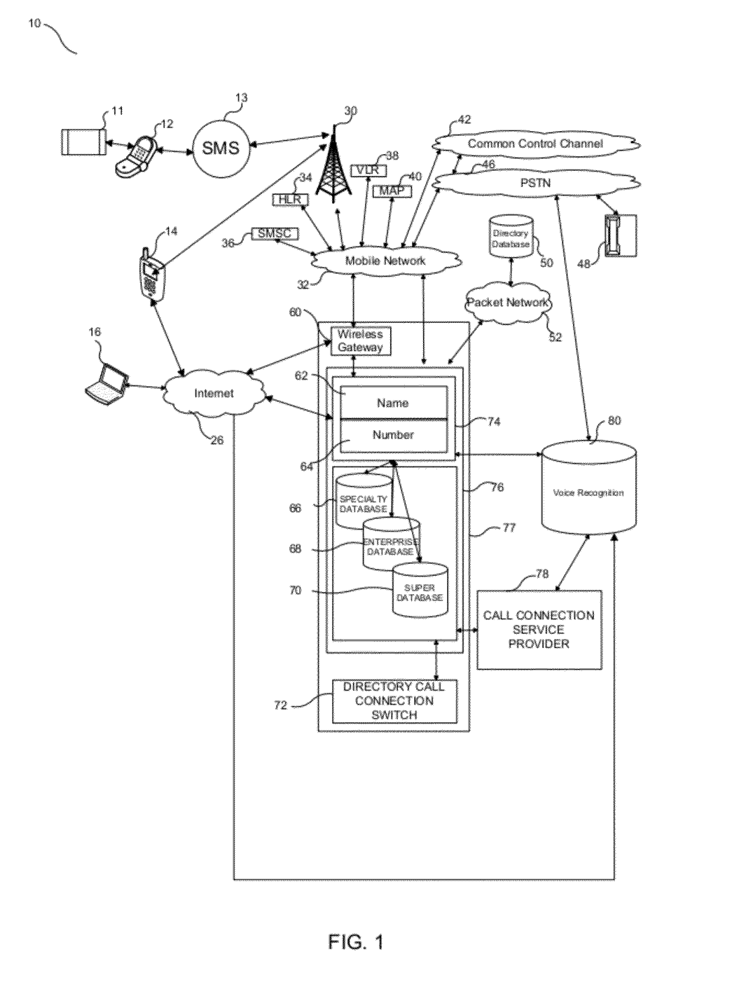

FIG. 1 illustrates a communication environment 10 including a mobile phone directory system 77 operable to provide a directory service to mobile phone users so that they can register their mobile phone numbers in an “open” mobile phone database by simply sending an SMS message 13 containing their preferred name from any mobile phone 12 to a special purpose wireless gateway (“directory gateway”) 60 designed to receive the incoming SMS message 13, extract the mobile phone number and the name from the SMS message 13 and a directory service process may create a unique directory listing for the mobile phone 12, which is now a subscriber. Extracting the mobile phone number from the SMS message 13 may include extracting the phone number directly from the body of the SMS message, if provided, or extracted from the data header of the SMS message. In alternative embodiments, the SMS message may instead be Unstructured Supplementary Service Data (“USSD”), an email, IM, TCP/IP message, and/or other electronic or mobile text messages.

The home location register (“HLR”) 34 is a database that contains details of each mobile phone user or subscriber that is authorized to use the mobile network 32. HLR 34 contains user information such as account information, account status, user preferences, features subscribed to by the user, user's current location, etc. HLRs are used by Mobile Switching Centers (“MSCs”) to originate and deliver arriving mobile calls. The visitor location register (“VLR”) 38 is a database of subscribers, similar to the HLR 34, which is used by the mobile network to temporarily hold profiles of roaming users (users outside their home area). VLR 38 data is based on the user information retrieved from HLR 34.

Each mobile network, such as mobile network 32, may have its own HLRs and VLRs. When a MSC detects a mobile user's presence in the area covered by its network, it first checks a database to determine if the user is in his/her home area or is roaming, i.e., the user is a visitor. When a user initiates a call, the switching equipment determines whether or not the call is coming from the device's home area. If the user is out of the home area, the area VLR sends out a request for information required to process the call. An MSC queries the HLR identified by the call for information, which it relays to the appropriate MSC, which in turn relays it to the VLR. The VLR sends routing information back to the MSC which allows it to find the station where the call originated, and, finally, the mobile device to connect.

Communications between the above elements are based on Signaling System (SS7) protocols and signaling. The mobile application part (“MAP”) 40 includes an SS7 protocol module which provides an application layer for the various nodes in Global System for Mobile Communications (“GSM”) and Universal Mobile Telecommunications System (“UMTS”) mobile core networks and General Packet Radio Service (“GPRS”) core networks to communicate with each other in order to provide services to mobile phone users. The MAP 40 is the application-layer protocol used to access the HLR 34, VLR 38, and SMSC 36. Common control channel 42 is used for signaling between base transceiver station (“BTS”) 30 and the mobile stations or devices, such as 12 and 14, and to request and grant access to mobile network 32. Common control channels are uplink and downlink channels within that are used to communicate between mobile stations and BTS's. A BTS or cell site is a piece of equipment that facilitates wireless communication between user equipment and a network. The public switched telephone network (PSTN) 46 includes telephone lines, fiber optic cables, microwave transmission links, cellular networks, communications satellites, and undersea telephone cables, all inter-connected by switching centers, thus allowing any telephone in the world to communicate with any other. PSTN 46 may be digital in its core and include mobile as well as fixed-line analog telephone systems.

Anyone wanting to connect to the subscriber need only know the subscriber's unique name (or registration Main Listed Number, mobile phone number) and SMS that name (or number) to the gateway 60 and the directory service process may search for the name, retrieve the subscriber number associated with the subscriber's mobile phone number (“number”) and send a special call request message to a call connection service provider 78 providing call connectivity between the subscriber and the mobile phone calling party 48. In other embodiments, the directory gateway may also accept an email, IM, TCP/IP message, or and other electronic message containing the name of a subscriber to connect with the subscriber. The electronic messages may be encrypted or triple encrypted using well-known encryption methods. The directory gateway may be associated with one or more access phone numbers or addresses (e.g., email, IP, URL, etc.) accessible by subscribers or mobile phone calling parties to either register a phone number or to request a call with a subscriber.

Embodiments of the present invention may relate to providing a world-wide mobile phone directory registration system 77 characterized by deploying a directory 74 enabling the mobile phone user 12 to become a subscriber by being able to register their mobile phone number in the directory 74 by sending a registration message 11 that includes the name to the directory 74 and the directory 74 receiving the registration message 11 from the mobile phone user 12 and then the directory 74 creating a name-number registration pair 62, 64 that may be used for future processing of calls when mobile phone 12 users SMS the subscriber's name to the directory 74.

Embodiments of the present invention may also provide a system and method for registering numbers, commonly called public switched telephone network (“PSTN”) mobile phone numbers, in a directory 74 by creating a system and method whereby any mobile phone user 12 in the world with the capability of sending a SMS, can send a registration message 11 containing the mobile phone user's name to the directory 74 and register their mobile phone number in the directory 74 and a system and method where a mobile phone caller 14 can send a call request message to the directory 74 and the directory 74 may return a call connection request message and forward that message to a directory call connection switch 72 capable of connecting the caller 14 to the subscriber 12. When referring to SMS, SMS may include all mobile phone messaging formats such as SMS, MMS, or unstructured supplementary service data (“USSD”) or instant messaging (“IM”) or e-mail or TCP/IP formats or any other methods of sending a wireless data packet of information. It is understood that a number may be a regular mobile phone number provided by the mobile phone operator and usually embedded in the SIM card or CDMA phone.

To register a number in the directory 74, a potential subscriber may send a registration message SMS 13 to an operator registration service in directory registration system 77. The registration message need only contain a name. A name could be a name, nick-name or Internet address or any combination. For example, a calling name could be John Smith or if John Smith was taken, John Smith27 or it could be a nick name “Smitty” or an email address jsmith@gmail.com, all of which would have to be unique to the directory 74 and any of which could be used to launch a call. Upon registration, a personal directory database web space portal may be provided by operator registration services and assigns the subscriber with a user name and pass code. A subscriber may login to their personal directory database web space with their user name and pass code and change the name or number of the name-number pair as long as name-number pair is unique and the number is unique.

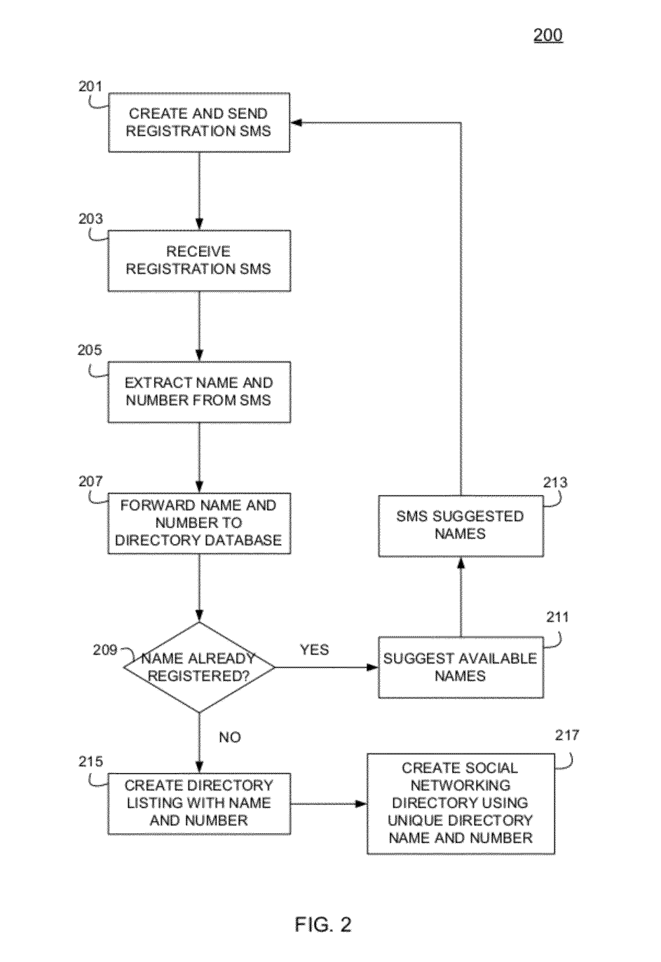

FIG. 2 presents a flowchart of a method 200 for registering a number in the directory system according to an embodiment of the present invention. A registration message SMS may be created and transmitted to directory gateway 60, step 201. The registration message SMS may be received by the directory gateway, step 203, which may be a purpose built wireless gateway that consists of a wireless modem connected to a PC server 76. When the SMS message 13 is received by the SIM card of the wireless gateway 60 the phone device logs the SMS message 13 in the SMS buffer and the gateway server 76 polls the wireless modem for SMS messages or the wireless modems sends the SMS messages to the gateway server 76. When the gateway server 76 receives the message the server extracts the mobile phone number and the name from the SMS message 13, step 205.

The name and number information may be converted, if not already converted, from an SMS format to a TCP/IP format or other message format applicable and sends the information to the directory database 50, step 207, entering the new subscriber data. Alternatively the SMS message can be sent to from the SMS Mobile Switching Center (SMSC) 36 directly to the directory database 50 by converting the message to TCP/IP and forwarding the information message to the directory database 50 via the IP address over packet network 52. Once the directory database 50 has received the registration message in a TCP/IP format, the directory database 50 may run a process to determine if the name has been taken by running a search and comparison between the existing names in the directory database 50 and the name proposed, step 209.

Name-number pairs 62, 64 can be indexed for fast retrieval of name-number pairs. If there are no duplicates, then the name may be registered along with the number in the name-number list, step 215. Once a name is listed, a confirmation SMS may be automatically sent to the registering party informing them that they have been successful in registration, or alternatively, an e-mail may accomplish the same function or an IM. Updates can be posted on social network sites such as Facebook if a subscriber has selected such an option and create a social networking directory using the name and number registered in the directory, step 217.

If the request is unsuccessful because the name is already in use a special directory registration process may run which suggests similar available names and e-mails, step 211 and SMS's them back to the registering party, step 213. The directory registration process can be enabled at a directory web portal accessed from a computer 16, via the Internet 26, where the potential subscriber can try different combinations until they have an acceptable name. Then the potential subscriber simply sends this name to the directory gateway 60 by a new registration message containing the acceptable name. Most likely many subscribers may just use their e-mail address as a name to eliminate the issue of duplicate names.

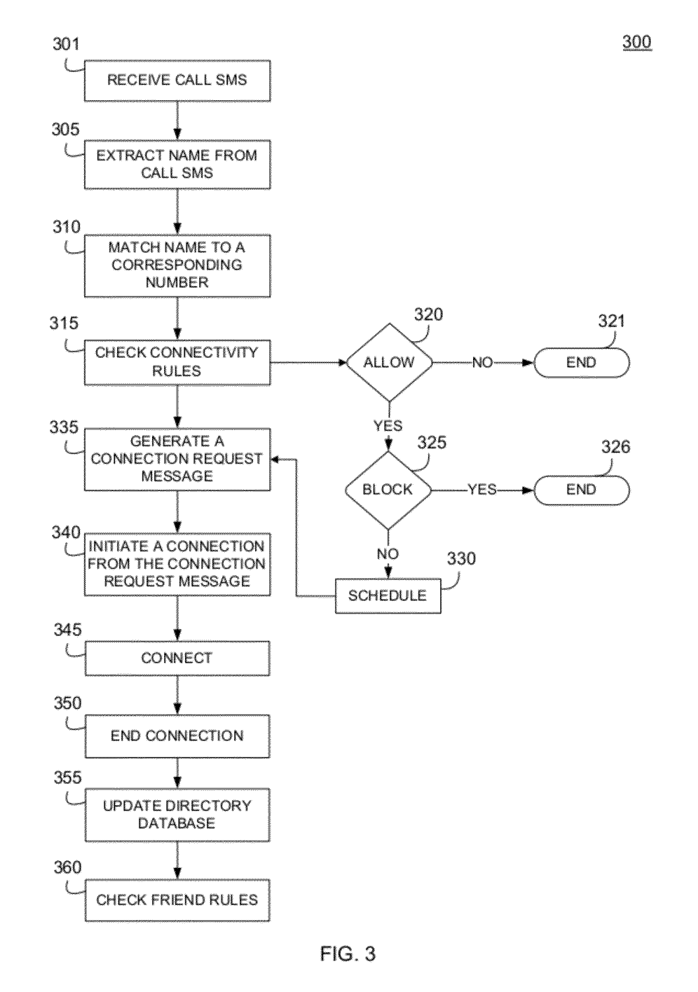

FIG. 3 presents a flowchart of a method 300 for completing calls using the directory system according to an embodiment of the present invention. Once a name is registered, if someone wants to call the subscriber from anywhere in the world, even if the subscriber has changed their number, as long as they have updated their number from a directory web portal, the caller need only send the name of the subscriber, often the subscriber's e-mail address, by sending an SMS including the subscriber name to the directory gateway 60. In other embodiments, the directory gateway may also accept an email, IM, TCP/IP message, or and other electronic message in lieu of an SMS to call the subscriber according to the steps described below.

The directory gateway 60 may receive the SMS message, step 301. A name is extracted from the SMS message, step 305 and a TCP/IP version of the message may be forwarded to the directory database 50 where the directory database 50 may match the name to a subscriber and retrieve the corresponding number from a name-number pair associated with the identified subscriber, step 310. In one embodiment, connectivity rules may be checked prior creating a call connection request, step 315. The connection may be determined whether if it is allowed, step 320 or blocked, step 325. If the call is not allowed, step 321 and/or blocked, step 326, the call request may be ended. Otherwise, if the call is allowed and not blocked, the call may be scheduled for a connection, step 330.

Upon scheduling a call connection, a connection request message may be generated, step 335 and sent to the call connection switch 72 or call connection switch provider 78 for call processing, step 340. The connection request message may have a different format for each of switch 72 and call connection service provider 78. Once the call connection switch 72 or call connection service provider 78 receive the connection request message the caller may be connected to the subscriber, step 345 in methods well known in the art form. The name-number number may be combined with the SMS message mobile phone number to create a call request message between an origination number (the SMS message mobile phone number) and a destination number (the subscriber's number). In an exemplary embodiment, the call connection switch 72 or call connection service provider 78 may call the origination number associated with the SMS message, to establish a first connection with the SMS sender, and call the destination number associated with the subscriber identified in the SMS message, to establish a second connection with the subscriber. The two calls may then be conference, joined, or bridged together to establish a call between the SMS sender and the subscriber.

The call connection may be terminated upon the conclusion of a conversation, step 350, and the directory database may be updated according to the connection, step 355. Updating the directory database may include updating the subscriber's personal user space. An update may include updating photos, voice clips, maps, micro-blog updates, videos, name/address changes, notes, messages, portal updates, connection activities, and other information that may be stored on a subscriber's phone or personal user space. The aforementioned update items may be delivery via one or more mobile directory social networking files. Friend rules in the directory database may be checked and the one or more friends' personal user space or social network site, and/or their mobile phones, are updated with updates of the subscriber, step 360.

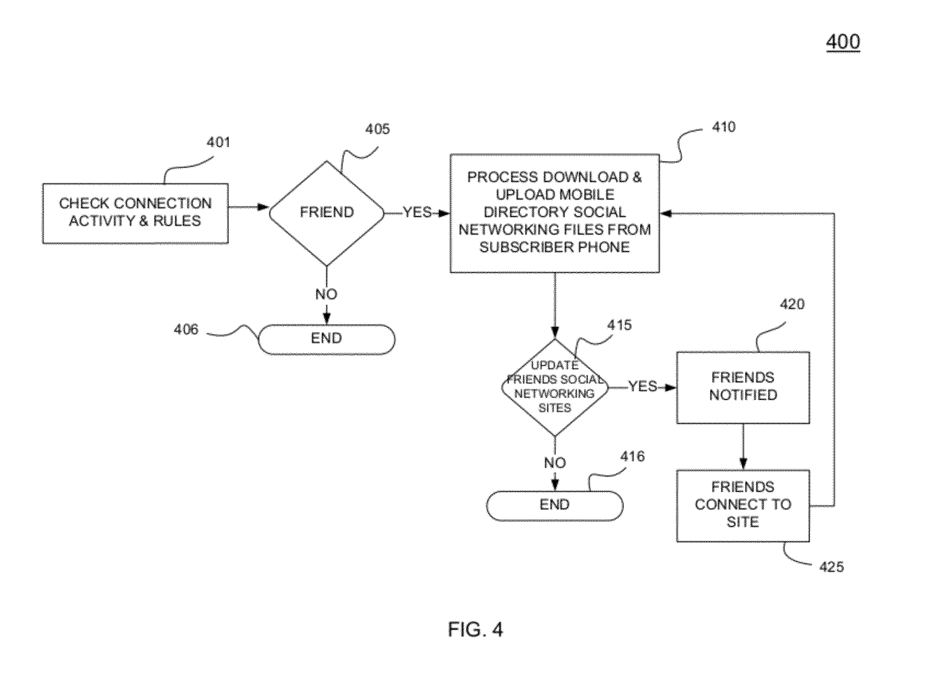

FIG. 4 presents a flowchart of a method 400 describing in further detail the process of creating a social networking directory according to an embodiment of the present invention. A subscriber's connection activity may be checked for one or more friends and rules associated with the one or more friends, step 401. The connection activity may include a set of rules configurable by the subscriber for providing additional features or services such as sending updates of SMS, pictures, blog updates, text, email, etc. to one or more friends' personal user space or a social networking site such as Facebook, Twitter, or MySpace, based on the rules set in the connection activity.

If there are no friends in the subscriber's connection activity, the process ends, step 406. If there are one or more friends in the connection activity, mobile directory social networking files or friend files may be downloaded to the subscriber's personal user space from the subscriber's phone, step 410. Mobile directory social networking files may include photos, voice clips, maps, micro-blog updates, videos, name/address changes, notes, messages, portal updates, connection activities, and other information that may be stored on the subscriber's phone or personal user space. A determination may be made whether to update the friends' social networking sites with the subscriber's updates, step 415. If a decision or rule to not update the friends' social networking sites, the process ends, step 416. Otherwise, friends may be notified via an update to their social networking sites, step 420. Subsequently, friends may connect to or visit the social networking site, step 425. The process may continue to download social networking files from the subscriber's phone.

### Security Number

When a subscriber first registers by sending an SMS message to the directory, the directory from the initiating registration SIM card creates a unique name-number combination as described but also sets a field storing the initiating registration SIM card number as a security number field. If the subscriber wants to make any changes to the name number pair from their mobile phone they must do so using the original initiating registration SIM card. A good example is when a subscriber is traveling. If a new SIM card is purchased to eliminate roaming charges by changing the number of the name-number pair to the new SIM card number, the subscriber must first send a “change message” to the directory from the initiating registration SIM card. In this way no one but the holder of the original initiating registration SIM card can make a change to the name-number combination.

### Change Message

A subscriber may wish to change a name-number to a number which is not a mobile phone number or a new mobile phone number. Provided the subscriber sends the change message to the directory gateway with the correct format and that the message is sent from a phone with the security number the change may be effected. When a name-number change request message is received by the directory, the directory checks the origination number of the SMS with the directory database to ensure that there is such a subscriber with this number registered.

### Directory Web Portal

A directory Internet portal, an Internet URL, or address with a home page requiring a user name and pass code, which when entered, may connect the subscriber to the subscriber's directory or user space. This may be a personal confidential space provided to the subscriber. The subscriber may also be asked to provide answers to a unique set of questions that only they know the answer to for security purposes. From the directory web portal the subscriber can change the security number by entering the web portal entering their user name and pass code, then answering one of the subscriber security questions as is industry standard. This ensures that their name calls cannot be intercepted. The subscriber can manage the name-number pair by changing the number associated with the name or changing the name checking with the name search engine and registering any name that is available with a limit of names per subscriber.

### Grouped Names

A grouped name may be a name corresponding to a group of numbers. If this name is texted to the directory gateway, then all of the associated numbers corresponding to the grouped name may be connected in a conference call in a similar fashion when two calls are joined between an origination number and a destination number, as described above.

### Call Triggered Social Networking

As the number of subscribers grows and more calls are made from the directory and there is increasing voice interaction from the subscriber base and more people become reliant on the directory as a means to keep in touch by voice, keeping in touch by other means such as change of address updates, recent phone graphs, notes to friends, etc., can become important to enhance the calling activity which is more likely as phones become PC's and PC's become phones. The integrated nature of the devices lends an opportunity for a phone call to trigger a social networking experience.

By linking the call patterns to social networking, the subscriber gets updates from friends they are currently active with. Current forms of social networking allow friend groups to grow to the point where actually most of the social networking friends are actually not really friends or even acquaintances and the social network subscriber gets bombarded by updates from non relevant sources. This issue may be rectified by triggering and limiting directory web portal social network updates to people they call in conjunction with other forms of social networking activities such as IM or uploading and downloading of images, text and information contained in allow and block lists.

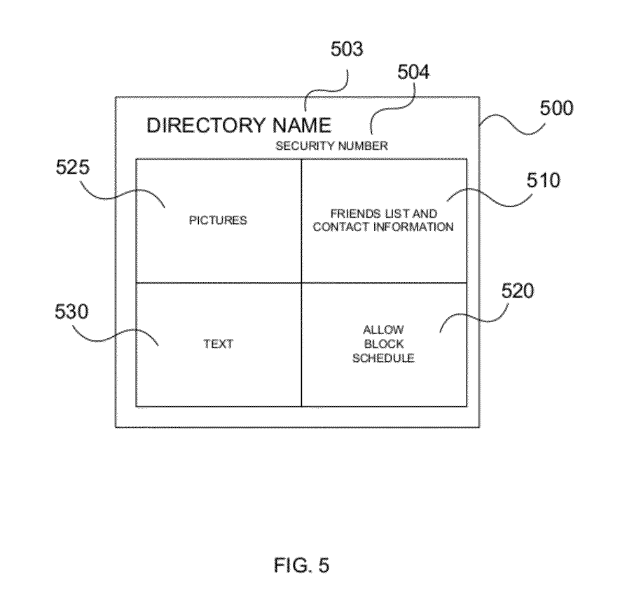

FIG. 5 presents a personal user space according to an exemplary embodiment of the present invention. User space 500 may include directory name 503, security number 504, friends list and contact information 510, allow/block schedule list 520 and schedule 520, pictures 525 and text 530. The directory name 503 includes the name of a subscriber associated with the personal user space. Security number 504, as described above may be a value associated with an initiating registration SIM card number. Friends list and contact information 510 includes a list of the subscriber's friends and their associated contact information (e.g., phone numbers, email address, usernames).

In the directory, web portal subscribers can “drop” or submit recent photographs, map clips, current address, video clips, friend updates, blog information, post notes and any other pertinent information that a friend may be interested in into picture 525 and text 530 in user space 500. Such activity combined with call connections will provide a friend the directory with information required for friend sorting. When a friend connects using the directory, the directory system checks to see if the call requesting person is a friend by checking the caller's mobile SIM number against the users friend list 510 and may then attempt to send an update to the mobile device so that not only does the person connect to the user but also gets some recent photos, voice clips, maps, micro-blog updates, address changes or any other piece of information stored in the subscriber's user space designated for a friend or with a special friend designation when a call request message is received by the directory gateway and the subscriber has elected to send or receive multimedia type messages including portal updates, email updates, MMS updates or WAP updates.

In addition, the user space has a list of friends or special friends and the friend or special friend has an update designation, the user space updates may automatically be sent to the friend or special friend when update changes are made to the user space. A given subscriber may simply update the user space by sending SMS messages or MMS messages with include pictures, sounds, etc. This way social networking can be accomplished without access to a PC and be totally mobile phone driven. Security measures such as security number 504 may be part of the process to ensure that the user's information was safe. If a SIM card is changed when traveling, an SMS message may be sent to update the space. Any friends marked for updates may receive the subscriber's mobile phone number while traveling and can dial the subscriber directly or send an SMS message to the directory and launch a call that way.

### Allow Lists/Block Lists

Referring to FIG. 5, in a user space 500, an allow list located in area 520 of the user space, may be a list of numbers or call names that when filled in, limits the callers who can use the system to access a user's call information or connect to the user using the system. The calling process may include a check of the user's allow list to see if it is active and if so the call process may check to see the call number is included in the list or if someone is trying to access the user's call information that it is included in the list. A user can enter telephone numbers or call names in a block list also located in area 520 of user space 500. Before processing a call, the process may check the block list first to see if the requested call is permitted or not or the caller requesting a connection may be blocked.

### Friend Updates

If a friend update list is provided any time a subscriber makes a change to the number associated to the subscriber's name-number pair, the system sends out an update to the subscriber's friend list by SMS, email or updates by Twitter or Facebook or any form of social networking as is the art form.

### Call Scheduling

In the user space 500, a subscriber can record a list of numbers and associated days and times and when call requests are received in area 520. The call system according to the present invention may check for a call schedule and if a call schedule is filled, the system according to the present invention may update the call name number with a new number as specified in the call schedule based on the time of day the call was requested. For example, if a most recent call request received indicates a new number that is not the same as the name-number, the name-number may be updated with the new number.

### SMS Registration Form

An SMS registration directory form may be a special SMS message that a potential subscriber can fill in and reply to, sending the SMS reply back to the directory where this information may be registered in the directory to enroll the subscriber. A Telco, for example, could send such a form to its entire subscriber base to simply inform potential subscribers of the new service to quickly and efficiently sign up the base of Telco mobile phone subscribers or pre-register the entire base and send the subscribers a registration form to provide a simple method of changing the registered information. This form could be requested from the gateway by sending a special SMS such as sending the text “form” or “registration” to the directory or filling out a form online with a web-based sign up.

The directory system may be implemented with an opt-out method. A Telco, for example, could decide to send SMS's to all mobile phone users letting them know the mobile phone directory is now accessible using SMS messages and if they don't want to be listed then reply to the SMS and the number may be removed from the system. This method of opt-out could increase the directory database of subscribers in the system very quickly using databases such as a database of airline members in flyer programs providing frequent flyer benefits. These databases have the added advantage of mailing address allowing the implementation of directory post and directory mail. A country's post office often have mailing address databases that can also be used to develop a post office offering or frequent flyer offering.

### Special Purpose Directories

Enterprises have a great deal of difficulty in keeping up with employees' personal mobile phone numbers especially if it is a worldwide organization with many offices around the world. Enterprises may wish to launch their own secure version of the directory called directory enterprise, with improved security and interconnection with enterprise databases 68, as shown in FIG. 1, and only open to internal staff and perhaps invited suppliers and clients depending on how the enterprise provisions the directory enterprise.

The super directory 70 illustrated in FIG. 1 incorporates names from many small databases by deploying a directory crawler which checks directories in an organized format adding extension to the names in a known predetermined published format ensuring there are no duplicates by adding company or location extensions separated by, for example, a period or dot. Once the new name has been uploaded, the new name registration in the super database 70 may be forwarded by email or other methods to the directory friends of the subscribers. To be sure of entering a unique name the subscriber could enter their email address as a name knowing that their email address is already unique worldwide.

A specialty directory may be a directory that may be customized for a special purpose. For example, a restaurant guide for a city called “GOOD EATS” could provide a special directory so that restaurants can register their restaurant names and numbers so that patrons of the service can call the restaurants by just knowing the restaurant name and SMS the name to the specialty database 66, and the specialty database 66 can have many customized processes such as playing an IVR and using voice recognition database 80 before connecting the call to the restaurant, giving a message of location, directions, etc., or specials. The directory system 10 could also forward the call to a customer feedback platform where comments can be taken or the caller can get the latest food updates. In addition, the directory can keep information on who used the system for data mining and forwarding of coupons etc.

### Directory Mobile Phone Application

For a more robust user experience the subscriber can download a directory application for mobile phones or devices from the mobile phone directory designed to simplify the social networking aspects of the product and roaming connectivity. For example, the application may make it simple to add pictures and text so that when calls are disconnected using the directory, properly identified photographic files may be automatically uploaded and downloaded to the subscribers the user's personal directory space. The directory application can make it simpler to connect as well by sorting call names and presenting to the subscriber the most likely list of directory names based on search criteria as well as keeping track of subscribers and their current phone numbers, even while traveling as well as keeping track of current subscribers current connectivity protocols such as SIP and subscriber current SIP IP address and keeping track of subscribers current mobile device status such as busy or do not disturb and others, and making this information available during the directory mobile phone call completion process and or updating the subscriber contact manager as the directory mobile phone information is updated.

One embodiment of the present invention may include a method for registering a mobile phone number with an operator registration service using a directory mobile device application and a subscriber with a registered mobile telephone number. The directory mobile device application may be pushed, pulled, or downloaded to a mobile device. A user of the mobile device with the installed application may enter setup data including mobile unique subscriber information. The mobile unique subscriber information may include a subscriber mobile device number, name and contact information and, if available, security and billing and payment information. The subscriber mobile phone number (SIM number or IMSI International Mobile Subscriber Identity) may be designated as a main listed number. The main listed number may be a primary phone number designed by the subscriber as the preferred phone number to be reached at. This Mail Listed Number can be changed by the subscriber accessing the subscriber Mobile Phone Directory provided subscriber web portal and accessing the subscriber personal space using a subscriber unique username and pass code and manually changing the subscriber main listed number or by the subscriber sending a special formatted SMS message to the gateway indicating the change of mail listed number.

The directory system may receive a mobile device electronic text message including a unique subscriber name provided by a mobile phone subscriber and a mobile phone number for the purposes of registering a name-number pair. The unique subscriber name and the mobile phone number are extracted from the electronic message. A name-number pair is generated with the extracted unique subscriber name and the mobile phone number. The mobile unique subscriber information and the unique subscriber name may be indexed by the subscriber mobile device number in a searchable directory database. A call request message is received from a calling party by use of the directory mobile device application, where the call request message includes the calling party's main listed number, an origination number, and a destination number. The origination number may be either a phone number or an IP address (for WiFi calls or 3G or 4G calls). The searchable directory database is searched to determine whether the destination number is the main listed number of the subscriber. A destination subscriber translation table is reviewed to determine a current destination number of the subscriber and a call is established between the origination number and the destination number. The destination number is the current destination number if the current destination number exists for the subscriber.

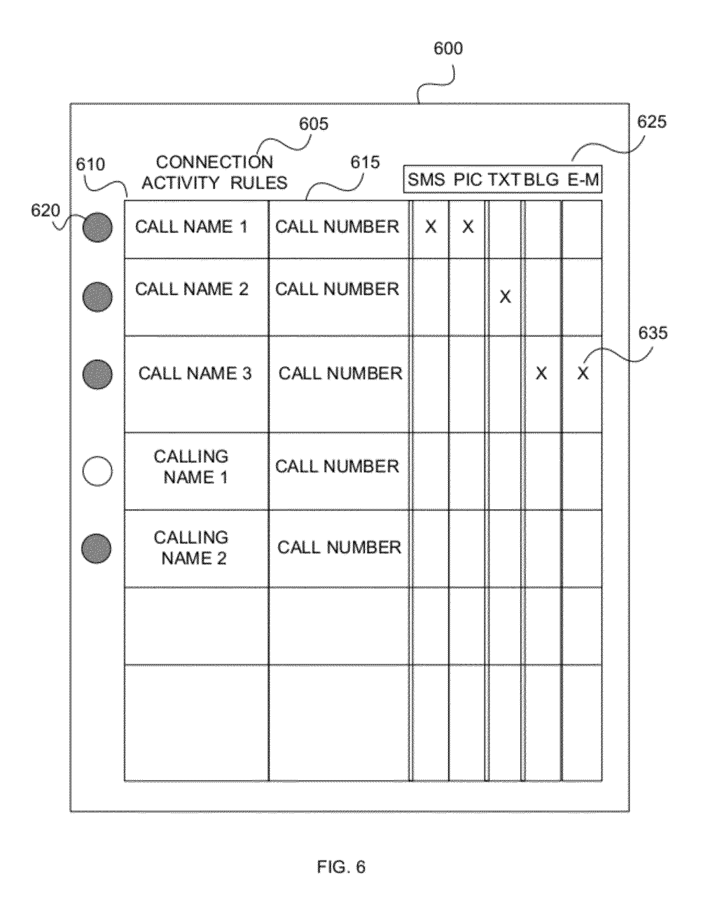

The directory mobile phone application may also allow users to create and mail physical post cards of photographs taken or stored on their mobile phones. Such a feature may be useful upon traveling where users of the directory application may want to send post cards to friends for sharing the users' travels. A photograph may be selected from a mobile phone or mobile device and copied and pasted into the directory mobile phone application. The photograph may then be sent to the user's personal space. The user's personal space directory may include a feature where photographs may be formatted into post cards to send to a post office for mailing to a specific physical address of a recipient or contact. The physical address may be stored in the contact information on the user's personal space directory or provided by a recipient upon notification of the sender requesting to send post cards to the recipient. Post cards may also be sent to friends configured in connection activities rules, which is discussed in further detail with respect to the description of FIG. 6. The post cards may be printed by the directory system or by a third party service and then send the post cards to any physical address in the world.

A subscriber may select a photograph, video recording, or text from their mobile device and copy these files into a temporary buffer, clipboard, or application memory of the directory mobile phone application. The subscriber selects from the application's contact manager one or more contacts and pastes the files to the contact. Selecting a done or send button by the subscriber will indicate completion and the application may then connect to the mobile phone directory service system. The Mobile phone directory service system receives the file(s) and searches the mobile phone directory service's searchable database to determine if the destination number is a subscriber.

One or more destination subscriber translation tables are selected where the media files are copied into the correct data field (e.g., pictures files into a current picture field, video images into a current video field, text into a current text field) and linked files such as text to image are associated as required. The director service server then copies current files into a destination subscribers' web portal space and sends notifications to the destination subscribers of the receipt of new images, text or video files for their review. The directory service system searches the subscriber destination number translation table for status of incoming data files and if the data files are set to ‘upload,’ the files are uploaded to the destination mobile device as instructed and as set in the mobile phone directory service's translation tables such as WiFi upload only, WiFi or 3G, or 4G.

The directory mobile phone application may also detect when a number has been changed on a subscriber's mobile phone. Such a change may be associated with a user changing a SIM card on their mobile phone or device. When there is a change of the number on a device installed with the mobile phone application, the number is synchronized with the directory to set the new number on the device as a current number (in a registered number data field of the database of the directory) where subsequent calls to the subscriber will be received. A change of the number on the subscriber's mobile phone device may also be detected upon the subscriber requesting a call using a new number not recognized as a current phone number in the registered number field associated with the subscriber's mobile phone. The current number may be synchronized with the directory database via packets over a data network. In another embodiment, if data communication is unavailable, synchronization data may be sent via SMS to the directory system if the current number uses a different country code than a previous number registered to the subscriber.

When call requests are made to a subscriber, the destination numbers in the requests directed to the subscriber are checked against the registered number data field associated with the subscriber in the directory database. If a registered number in the data field is present, and if the registered number is different than the current number, the destination number may be replaced or updated with the current number to establish phone calls without incurring inbound roaming charges. In another embodiment, an alternative method for subscriber registration may include determining whether a registered number exists in the directory database for a user making an outbound call with a mobile phone installed with the directory mobile phone application. If not, a new current number of the subscriber's mobile phone may be automatically registered in a name-number data record associated with the subscriber as the call request is being processed. The directory database may be checked upon every phone call with a mobile phone installed with the directory mobile phone application to synchronize a registered phone number of a subscriber on the directory database with a phone number used on the mobile phone.

According to one embodiment, the directory mobile phone application is also operable by a subscriber to place IP calls using Wi-Fi. The application may check the availability of a data network connection suitable for making an IP call on the mobile phone. Making an IP call is not limited to using Wi-Fi and may include using 3G, 4G, LTE, Enhanced Data rates for GSM Evolution (“EDGE”), Universal Mobile Telecommunications System (UMTS), and other wireless data communication networks. The data networks carrying the IP calls may be partially or fully managed so as to control quality of the IP calls. Service level agreements may also be established between a subscriber and the directory system provider. The service level agreements may specify a guaranteed level of service, security features, and a cost for providing an IP call or hybrid call (one IP call leg with one PSTN leg) at the specified level of service and security.

A list if available wireless networks may be detected and provided by the directory mobile phone application for a user to connect to. If a data network connection is of sufficient quality, the application is able to make a call via a Session Initiation Protocol (“SIP”) or a Voice over Internet Protocol (“VoIP”) session to bridge a first leg established on a data connection (Wi-Fi) from the mobile device with a second leg to a destination phone number on a PSTN. In establishing an IP call, the directory mobile phone application may send data including an origination current IP address and a destination phone number to the directory gateway or a call switch to connect a call between the first leg and the second leg. When receiving the call request, the directory mobile phone process will update a subscriber name-number translation table to include the new current subscriber IP address and current protocol.

When placing IP calls, the IP address of the mobile phone installed with the directory mobile application may be set as the current number, or in this case, the current address, where calls to the subscriber are to be received. An IP address used to make an IP call is synchronized with the directory database in the same manner a phone number would be. When inbound call requests are made to a subscriber, the directory database is checked for a current number/address associated with the subscriber. If the subscriber is associated with a current IP address, calls to the subscriber will be established via SIP or VoIP. The directory mobile phone application may also be able to detect when a connection to a current address has ended. When this occurs, the directory may receive a message from the directory mobile phone application to revert an IP address recorded as the current number/address to a previously registered number.

According to an embodiment of the invention, a directory mobile device application may present to a subscriber, an option of receiving inbound calls by VoIP and making outbound calls by VoIP via a mobile phone directory server when the subscriber enters a WiFi Zone or has 3G or 4G connectivity. An acceptance of the VoIP calling option by the subscriber and an IP address from a mobile device of the subscriber is received. The searchable database of the directory service system is searched for the subscriber's main listed number, and a current number field is identified to update a previous current number with the IP address. The searchable database is also searched for the destination number to determine whether a destination number for an outbound call is an existing subscriber, and retrieve the destination current number which may be an IP address.

To make a call, the subscriber in the WiFi zone selects a contact from a contact manager in the directory mobile phone application. An electronic message is received from the subscriber by the directory service system where the destination number and an origination number IP address are extracted from the electronic message. The directory service system places a VoIP call to the subscriber at the origination number IP address and a call to the destination number on a PSTN. The VoIP call is bridged to the destination number on the PSTN. In another embodiment, a destination subscriber translation table is searched and a destination current number for an outbound call is identified as an IP address. The call may be established to the destination number as an IP call that bridges a call to an origination number to a call to the destination current number, where the destination number may be a PSTN number or VoIP IP address.

In another embodiment, the directory mobile phone application may provide includes busy number handling. When receiving a call request, the directory performs a check on a current number to check whether the number is engaged in an on-going call. If so, the directory system may return a message to the requester of the call that the destination number is engaged and will be queued. When both the origination number and the destination number are available, the call request will resume and be carried out automatically.

On a successful call completion, the destination subscriber translation table may set a call status field to ‘busy’ for the duration of the call and is reset to ‘available’ upon completion of the call. The subscriber may also set a status option selection to ‘do not disturb’ and the directory mobile device application sends an update of the status option selection to the mobile phone directory server. In one embodiment, the searchable database is searched for a main listed number associated with the subscriber. A translation table associated with the main listed number is identified and a status field is updated to ‘do not disturb.’

According to another embodiment for conducting a call, an electronic message is received from the subscriber to request a call. The call request may be received from the subscriber to setup a call with a destination number where the destination number is associated with another subscriber. The searchable database is searched to identify a main listed number associated with a destination party. A status field in a destination subscriber translation table of a destination number of the destination party is identified as do not disturb. A first notification message is sent to the destination party that the subscriber is attempting a call to the destination party and a second notification message is sent to the subscriber that the destination party is not available.

If the destination number subscriber is on the phone already and the destination call status field in the searchable database directory is set to busy, the mobile phone directory system will not attempt to set the call up, and instead send a message back the subscriber that the destination number is busy. The subscriber may configure in their contact options to retry a busy call. The mobile phone directory system sets the translation table to reconnect and as soon as the destination subscriber terminates the call the calling subscriber is connected to the called destination subscriber.

A message may be sent to a busy destination subscriber that a subscriber is trying to reach them and optionally with the subscriber's identity displayed. The calling subscriber can select more than on contact to complete a call with. The mobile phone directory system can set up conference calls and search for each destination number in the searchable database to determine if the destination numbers are subscribers, and if they are not subscribers directly connecting them to the conference call. If they are subscribers, translation tables associated with their main list numbers are checked to determine a destination subscriber number, a current number, and a current status. Each call can be completed based on the translation table's current status information for each conference call destination number, and by bridging calls made to each destination number or subscriber together in a single conference call.

According to another embodiment, an electronic message is sent to each subscriber destination number by SMS, USSD or electronic text message to each registered mobile phone number's main listed number informing each participant of a pending conference call. If a subscriber fails to join a conference call, the destination subscriber may retrieve the electronic message and reply to indicate to the mobile phone directory system a need to reenter the conference call. The message may include a conference ID that is received by the mobile phone directory system and extracted. The conference ID and the recipients mobile phone number associated with the conference call request are used to connect the subscriber to a conference bridge in progress using the main listed number or the current number in the subscriber translation table. According to one embodiment, the electronic message may be an email containing a one-time-use time-to-live conference call ID, and a reply to this email is operable to connect the subscriber's destination number to the conference bridge.

In yet another embodiment, the directory mobile phone application may provide an “away message”-like feature. When travelling, the directory mobile phone application has a travel option that is available where the user may select friends or contacts for notification that the user is travelling abroad. The message may include a notice notifying the selected individuals that the user is currently traveling and that the user may be contacted via the directory system and/or by downloading the directory mobile phone application to their phones. For example, the message may include “Please text (name) to (directory number) or download directory mobile phone application at www.directoryservice.com.”

### Connection Activity

Referring to FIG. 6, the personal space may have a connection activity page 600 which may be similar to a phone bill. Connection activity page 600 provides additional features not provided by a phone bill as it allows the subscriber to click a radio button 620 to identify a friend associated with a call name 610 and call number 615, and mark 635 the friend for special services 625 such as SMS, pictures, blog updates, text, or e-mail. If a subscriber sends a picture (or a link or moves files to their space depending on the rules 605 set by the subscriber and preferences of the friend) to his or her user space, all those friends marked for receiving pictures may get copies of the picture. Such a feature may be convenient for keeping up with friends and family over holidays or vacations.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A method for registering a mobile phone number with an operator registration service, the method comprising:
receiving an electronic message including a unique subscriber name provided by a mobile phone subscriber;
extracting the unique subscriber name from the electronic message and a mobile phone number associated with the electronic message corresponding to the mobile phone subscriber;
generating a name-number pair with the extracted unique subscriber name and the mobile phone number;
indexing the name-number pair in a searchable directory database;
receiving a call request message from a calling party, the call request message including the unique subscriber name and an origination phone number;
retrieving the name-number pair associated with the unique subscriber name in response to receiving the call request message; and
establishing a call between the origination phone number and the mobile phone number.

2. The method of claim 1 wherein the electronic message is at least one of a SMS, USSD, and mobile text message.

3. The method of claim 1 wherein the call request message is at least one of a SMS, USSD, and mobile text message.

4. The method of claim 1 wherein receiving the electronic message comprises receiving a registration message to register the unique subscriber name with the mobile phone number, and an operator registration service providing a username and pass code to the mobile phone subscriber upon registration for access to a personal directory database web space portal.

5. A system for registering a mobile phone number with an operator registration service, the system comprising:
a directory gateway operative to:
receive one or more electronic messages, each of the electronic messages including a unique subscriber name provided by a mobile phone subscriber;
extract the unique subscriber name from the electronic message and a mobile phone number associated with the electronic message corresponding to the mobile phone subscriber;
generating a name-number pair with the extracted unique subscriber name and the mobile phone number; and
a searchable directory database operative to:
receive the name-number pair from the directory gateway;
determine whether the unique subscriber name of the name-number pair exists in the directory database; and
indexing the mobile phone number with the unique subscriber name in a name-number pair record.

6. The system of claim 5 wherein the one or more electronic messages are at least one of SMS, USSD, and text message

7. The system of claim 5 wherein the one or more electronic messages are at least one of encrypted electronic messages, and triple encrypted electronic messages.

8. The system of claim 5 wherein receiving the one or more electronic messages comprises receiving registration messages to register unique subscriber names with mobile phone numbers.

9. The system of claim 8 wherein upon registration of a unique subscriber name with a mobile phone number, a username and a pass code are provided to access to a personal directory database web space portal.

10. The system of claim 9 wherein the username and pass code provides access to the personal directory database web space portal by the mobile phone subscriber to change the name or number associated with the name-number pair provided that the name or number is unique.

11. The system of claim 8 wherein registration of the unique subscriber name with the mobile phone number is completed by a mobile phone directory service application.

12. A system for retrieving a mobile phone number from an operator registration service to establish a call, the system comprising:
a directory gateway operative to:
receive a call request message, the call request message identifying a unique subscriber name provided by a caller;
extract the unique subscriber name from the call request message and an origination phone number associated with the call request message corresponding to the caller;
a searchable directory database operative to:
receive the unique subscriber name and the origination phone number from the directory gateway;
identify a mobile phone subscriber associated with the unique subscriber name;
retrieve a destination phone number associated with the mobile phone subscriber; and
a call connection switch operative to:
establish a first call with the origination phone number and a second call with the destination phone number; and
bridge the first and second calls together to establish a call between the origination phone number and the destination phone number.

13. The system of claim 12 wherein the call request message is at least one of a SMS, USSD, and mobile text message.

14. The system of claim 12 wherein the directory database is further operative to receive a registration message to register the unique subscriber name with a mobile phone number.

15. The system of claim 14 wherein upon registration of the unique subscriber name with the mobile phone number, a username and pass code are provided to access to a personal directory database web space portal to change the unique subscriber name or the mobile phone number provided that a changed name or number is unique.

16. The system of claim 14 wherein registration of the unique subscriber name with the mobile phone number is completed by a mobile phone directory service application.

17-43. (canceled)
